(19) United States
(12) Patent Application Publication
(10) Pub. No.: US 2024/0084623 A1
(43) Pub. Date: Mar. 14, 2024

(54) CAR ACCESS ASSEMBLY INCLUDING A HANDLE OF A CAR DOOR

(71) Applicant: MINEBEA ACCESSSOLUTIONS ITALIA S.P.A., Pianezza (IT)

(72) Inventors: Myriam AKANOU, Pianezza (IT); Anthony GUERIN, Pianezza (IT); Antonio LABALESTRA, Pianezza (IT)

(73) Assignee: MINEBEA ACCESSSOLUTIONS ITALIA S.P.A., Pianezza (IT)

(21) Appl. No.: 18/463,643

(22) Filed: Sep. 8, 2023

(30) Foreign Application Priority Data
Sep. 8, 2022 (EP) 22194517.3

(51) Int. Cl. E05B 79/06; E05B 81/76

(52) U.S. Cl. CPC E05B 79/06; E05B 81/77

(57) ABSTRACT

A car access assembly includes a handle configured to be attached on a car door and an electronic sensing unit. The electronic sensing unit includes a sensor configured to be attached on an extension portion of the handle and/or to a bracket configured to cooperate with the handle. The extension portion and/or the bracket is configured to be installed on or facing an internal side of a part of the car door extending according to a reference plane. The assembly also includes a fixing mechanism for the sensor so that a constraint applied to the handle is transmitted to the sensor for detection of a command via the extension portion and/or the bracket.

### CROSS-REFERENCE TO RELATED APPLICATIONS

This application is claims priority to and the benefit of EP 22194517.3 filed on Sep. 8, 2022. The disclosures of the above applications are incorporated herein by reference.

### FIELD

The present disclosure relates to a car access assembly including a handle of a car door.

### BACKGROUND

The statements in this section merely provide background information related to the present disclosure and may not constitute prior art.

It is known to have a car door with a closing system that can be released with a mechanical arrangement built in a handle of the car. Typically, the user seizes the mechanical arrangement located on the handle to trigger it. The user can then, in a same move, pull the door to open it.

This provision gives satisfaction in that the user is intuitively guided to operate the door because the mechanical arrangement reacts when gripping the handle.

It is also known to use electronic detectors in the automotive industry to facilitate the user command by limiting the force that should be applied to execute a task. Here, it is also known to add a sensing unit to a car door to unlock it for opening.

The use of a sensing unit can, however, result in a decrease of the user experience quality since the sensing unit could be located in a place that is not intuitive for the user.

The implementation of a sensing unit in a handle could also lead to another opening method that requires practice for the user. For example, it could be necessary to push or touch a button and then pull the door which implies realizing two different movements in a precise order to open the door.

There is, therefore, a need for a better integration of the electronic sensing unit in a handle to facilitate the handling by the user.

The present disclosure aims to solve all or some of the disadvantages mentioned above.

### SUMMARY

This section provides a general summary of the disclosure and is not a comprehensive disclosure of its full scope or all of its features.

For this purpose, the present disclosure relates to a car access assembly including a handle configured to be attached on a car door and an electronic sensing unit, the electronic sensing unit including:

a sensor configured to be attached on an extension portion of the handle and/or to a bracket configured to cooperate with the handle, the extension portion and/or the bracket being configured to be installed on or facing an internal side of a part of the car door extending according to a reference plane,

a fixing mechanism for the sensor, the fixing mechanism being configured to attach together to the part of the car door, the extension portion and/or the bracket, and the sensor so that a constraint applied to the handle is transmitted to the sensor for detection of a command via the extension portion and/or the bracket.

This provision permits the ability to have a sensor that is fixed with respect to the internal side of the car and, at the same time, biased by a constraint applied to the handle because the extension portion and/or the bracket is transmitting the constraint. Given that the sensor cooperates simultaneously with the part of the car door and with the handle (directly or indirectly), the sensor can measure a constraint and therefore a command from a user pushing or pulling the handle.

According to an aspect of the disclosure, the internal side refers to the side of the part of the car door facing the interior of the car. In one form, the part may optionally include an external side facing the outside of the car and opposite to the internal side.

According to an aspect of the disclosure, the sensor includes at least one strain gauge, the at least one strain gauge being configured to be deformed when the constraint is applied to the handle.

The extension portion and/or the bracket permits the transmittance of the constraint applied on the handle so as to deform the at least one strain gauge. Thus, when a user pushes or pulls the handle of the car, it implies the deformation of the at least one strain gauge.

According to an aspect of the disclosure, the sensor is configured to close and to release a locking mechanism of the car door.

In one form, when a compressing pressure is applied to the sensor transversally to the reference plane, namely when pushing the door towards a closed position, a locking command may optionally be acquired.

In one form, when an extending pressure is applied to the sensor transversally to the reference plane, namely when pulling the door towards an open position, a releasing command may optionally be acquired.

In other words, in only one movement, the user can unlock and open the door of the car or close and lock the door of the car.

According to an aspect of the disclosure, the at least one strain gauge may be a full-bridge strain gauge or a half-bridge strain gauge.

According to an aspect of the disclosure, the handle is an outside handle of the car for example on the driver side. As used herein, the term “car” is understood to include every kind of vehicle in the automotive industry including bus, truck, personal vehicles etc.

According to an aspect of the disclosure, the extension portion of the handle and/or the bracket extends parallel to the reference plane, the extension portion and/or the bracket being located between the internal side and the sensor transversally to the reference plane.

This provision implies that the car access assembly is compact and does not present an over thickness transversally to the reference plane.

According to an aspect of the disclosure, the extension portion or the bracket cooperated by surface cooperation with the internal side.

Alternatively, the at least on sensor can be located between the internal side and the extension portion or the bracket. In this alternative configuration, the extension portion and/or the bracket can present some portions that can cooperate by surface cooperation with the internal side.

In another configuration, there car access assembly includes both the handle with the extension portion and the bracket, the bracket being configured to cooperate with the extension portion. The bracket, or alternatively the extension portion, can cooperate with internal side.

Different constructions are possible provided that the extension portion and/or the bracket are respectively in contact with the sensor and with the internal side.

According to an aspect of the disclosure, the extension portion and/or the bracket presents a recess adapted to receive the sensor.

The geometrical feature permits more efficient transmission of the constraint applied to the handle by a user to the sensor.

According to an aspect of the disclosure, the bracket is configured to be clipped to the handle.

According to an aspect of the disclosure, each sensor includes two strain gauges mounted on the support. In one form, the support may optionally be constituted of a metal material.

According to an aspect of the disclosure, the fixing mechanism includes a main fastener which is configured to extend according to a main direction transversal to the reference plane, the main fastener being configured to cooperate with the sensor, the extension portion and/or bracket, the part of the car door and the handle.

The main fastener allows a good hold in place of the sensor. Therefore, the sensor is maintained in position with respect to the part of the car and is able to perceive the constraint applied on the handle.

According to an aspect of the disclosure, a support of the sensor, the extension portion and/or bracket, the part of the car door each presents a corresponding through opening for passage of the main fastener.

The through openings are aligned so that the main fastener is able to pass therethrough.

According to an aspect of the disclosure, the handle includes a socket adapted to cooperate with the main fastener.

According to an aspect of the disclosure, the main fastener includes a head configured to cooperate with the support and/or the extension portion and/or bracket.

According to an aspect of the disclosure, each sensor includes two strain gauges mounted on the support. In one form, the support may optionally be constituted of a metal material.

According to an aspect of the disclosure, the main fastener is a screw. A screw is an efficient way to secure the support.

According to an aspect of the disclosure, the main fastener is a screw and the socket includes a threaded portion.

A screw is an efficient way to secure the support and the extension portion and/or bracket on the internal side.

The threaded portion can be a threaded insert introduced in an orifice of the handle.

According to an aspect of the disclosure, the support has at least one attaching portion configured to be fixed to the extension portion and/or bracket thanks to a corresponding additional fastener of the fixing mechanism.

According to an aspect of the disclosure, the at least one attaching portion is an orifice or a slot configured for receiving the corresponding additional fastener which is for example a screw, possibly with mounting ring(s).

In one form, the support may optionally present two attaching portions, the strain gauges being located between the two attaching portions according to a longitudinal direction of the support.

According to an aspect of the disclosure, the through opening of the support is located between the two strain gauges according to the longitudinal direction of the support.

According to an aspect of the disclosure, the car access assembly includes an additional fixing element for fixing the handle on the part of the car. In one form, the additional fixing element may optionally be a screw configured to be cooperating with the handle and with the part of the car.

According to an aspect of the disclosure, the electronic sensing unit includes two distinct sensors and two corresponding fixing mechanisms.

In this configuration both sensors are located on the same side than the internal side as described above.

According to an aspect of the disclosure, the electronic sensing unit includes a further sensor mounted on the external side of the part of the car door, the car access assembly including a further fixing element for maintaining the further sensor on the external side.

According to an aspect of the disclosure, the further sensor is identical to the above described sensor, only its location is different. The fact of having a further sensor at another location improves the quality of the acquisition of solicitation of the handle.

According to an aspect of the disclosure, the further fixing element includes a first part adapted to be received in a further recess of the handle and a second part configured to cooperate with the first part.

According to an aspect of the disclosure, the first part is a nut and the second part is a screw extending transverse to the reference plane. The extension portion and/or bracket, the part of the car and the further sensor each presenting a through opening for passage of the screw.

According to an aspect of the disclosure, each strain gauge is linked to a signal transmitting device of the car access assembly.

Each signal transmitting device includes electrical wire(s) or flexible printed circuit board(s) configured to transmit a signal from the sensor. The wires can be shielded or not.

According to an aspect of the disclosure, the handle is an outside handle of the car for example on the driver side. As used herein, the term “car” is understood to include every kind of vehicle in the automotive industry including bus, truck, personal vehicles etc.

According to an aspect of the disclosure, the car access assembly includes the car door.

The present disclosure also concerns a car including at least one car access assembly as described above.

The different aspects defined above that are not incompatible can be combined.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective exploded view of a car access assembly with sensors in accordance with the teachings of the present disclosure;

FIG. 2 is a perspective cross-sectional view of the car access assembly of FIG. 1;

FIG. 3 is a perspective view of a car access assembly of a second configuration in accordance with the teachings of the present disclosure;

FIG. 4 is a perspective view of the car access assembly of FIG. 3, illustrated with the handle is removed;

FIG. 5 is a perspective exploded view of a car access assembly of a third form in accordance with the teachings of the present disclosure; and

FIG. 6 is a perspective exploded view of a car access system of a fourth form in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the following detailed description of the figures defined above, the same elements or the elements that are fulfilling identical functions may retain the same references so as to simplify the understanding of the disclosure.

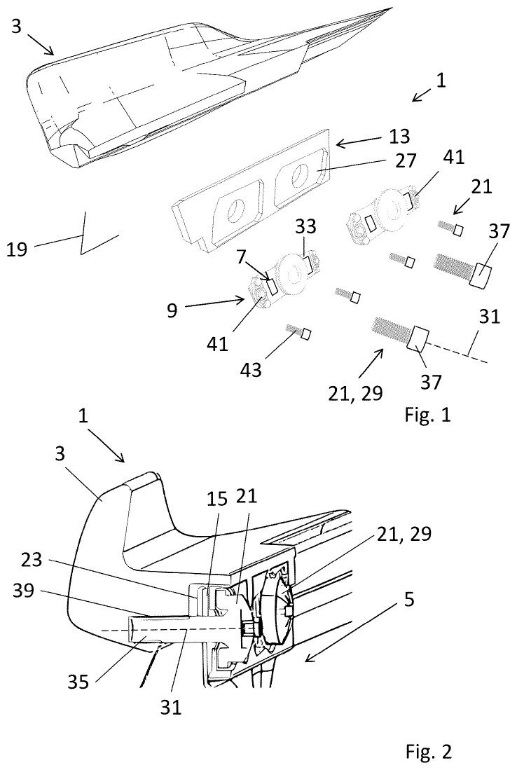

As illustrated in FIGS. 1 to 6, a car access assembly 1 including a handle 3 is configured to be attached on a car door 5 and an electronic sensing unit 7.

The electronic sensing unit 7 includes two sensors 9 configured to be attached on an extension portion 11 of the handle 3 and/or to a bracket 13 configured to cooperate with the handle 3, the extension portion 11 and/or the bracket 13 being configured to be installed on or facing an internal side 15 of a part 17 of the car door 5 extending according to a reference plane 19.

The electronic sensing unit 7 includes a fixing mechanism 21 for each sensor 9, the fixing mechanism 21 being configured to attach together to the part 17 of the car door 5, the extension portion 11 and/or the bracket 13, and the sensor 9 so that a constraint applied to the handle 3 is transmitted to the sensor 9 for detection of a command via the extension portion 11 or the bracket 13.

Given that each sensor 9 cooperates simultaneously with the part 17 of the car door 5 and with the handle 3 (directly or indirectly), the sensor 9 can measure a constraint and therefore a command from a user pushing or pulling the handle.

The internal side 15 refers to the side of the part 17 of the car door 5 facing the interior of the car. The part 17 includes an external side 23 facing the outside of the car and opposite to the internal side 15.

Each sensor 9 includes at least one strain gauge 25, the at least one strain gauge 25 being configured to be deformed when the constraint is applied to the handle 3.

The extension portion 11 and/or the bracket 13 permits transmission of the constraint applied on the handle 3 so as to deform the at least one strain gauge 25. Thus, when a user pushes or pulls the handle 3 of the car, it implies the deformation of the at least one strain gauge 25.

The sensor 9 is configured to close and to release a locking mechanism of the car door 5.

When a compressing pressure is applied to the sensors 9 transversally to the reference plane 19, namely when pushing the door towards a closed position, a locking command is acquired.

When an extending pressure is applied to the sensor 9 transversally to the reference plane 19, namely when pulling the door towards an open position, a releasing command is acquired.

In other words, in only one movement, the user can unlock and open the door of the car or close and lock the door of the car.

The at least one strain gauge 25 may be a full-bridge strain gauge or a half-bridge strain gauge.

The handle 3 is an outside handle of the car for example on the driver side. As used herein, the term “car” is understood to include every kind of vehicle in the automotive industry including bus, truck, personal vehicles etc.

The extension portion 11 of the handle 3 and/or the bracket 13 extends parallel to the reference plane 19.

The bracket 13 is, for example, located between the internal side 15 and the sensors 9 transversally to the reference plane 19 as depicted in the configuration of FIGS. 1 and 2 according which there is no extension portion 11. The bracket 13 cooperates by surface cooperation with the internal side 15.

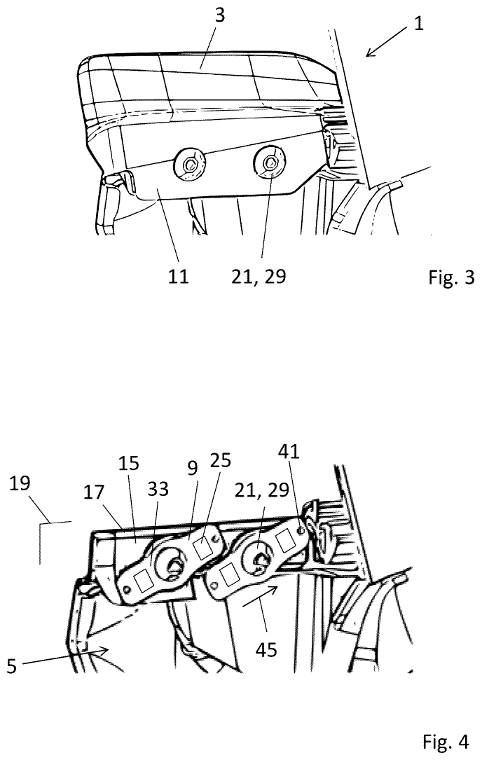

Alternatively, the sensors 9 can be located between the internal side 15 and the extension portion 11 in the configuration depicted in FIGS. 3 and 4. In this alternative configuration, the extension portion 11 can present some portions that can cooperate by surface cooperation with the internal side 15.

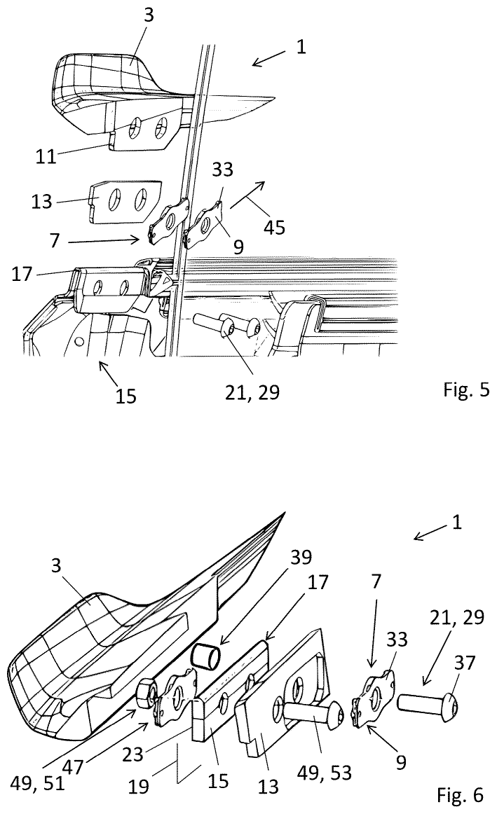

In another configuration depicted in FIG. 5, the car access assembly 1 includes both the handle 3 with the extension portion 11 and the bracket 13, the bracket 13 being configured to cooperate with the extension portion 11. The bracket 13 or alternatively the extension portion 11 can cooperate with internal side 15 depending on the construction choice.

Different constructions are possible provided that the extension portion 11 and/or the bracket 13 are respectively in contact with the sensors 9 and with the internal side 15.

The extension portion 11 and/or the bracket 13 presents two recess 27 adapted to receive the sensors 9.

The bracket 13 is configured to be clipped to handle 3 as shown on FIG. 1.

The fixing mechanism 21 includes, for each sensor 9, a main fastener 29 which is configured to extend according to a main direction 31 transversal to the reference plane 19, the main fastener 29 being configured to cooperate with the corresponding sensor 9, the extension portion 11 and/or bracket 13, the part 17 of the car and the handle 3.

The main fasteners 29 allow a good hold in place of the sensors 9. Therefore, each sensor 9 is maintained in position with respect to the part 17 of the car and is able to perceive the constraint applied on the handle 3.

A support 33 for a corresponding sensor 9, the extension portion 11 and/or bracket 13, the part 17 of the car door 5 each presents a corresponding through opening for passage of the corresponding main fastener 29.

The through openings are aligned so that the main fastener 29 is able to pass therethrough.

The handle 3 includes a socket 35 adapted to cooperate with the main fastener 29.

Each main fastener 29 includes a head 37 configured to cooperate with the support 33 and/or the extension portion 11 and/or bracket 13.

Here, each sensor 9 includes two strain gauges 25 mounted on the support 33. The support 33 is constituted of a metal material.

The main fastener 29 is a screw and the socket 35 includes a threaded portion 39. The threaded portion 39 can be a threaded insert introduced in an orifice of the handle 3 as shown on FIG. 6.

The support 33 has at least one attaching portion 41 configured to be fixed to the extension portion 11 and/or bracket 13 thanks to a corresponding additional fastener 43 of the fixing mechanism 21.

The at least one attaching portion 41 is an orifice or a slot configured for receiving the corresponding additional fastener 43 which is for example a screw, possibly with mounting ring(s).

Here, the support 33 presents two attaching portions 41, the strain gauges 25 being located between the two attaching portions 41 according to a longitudinal direction 45 of the support 33.

The through opening of the support 33 is located between the two strain gauges 25 according to the longitudinal direction 45 of the support 33.

Each sensor 9 includes two strain gauges 25 mounted on the support 33. The support 33 is constituted of a metal material.

The car access assembly 1 can include an additional fixing element for fixing the handle on the part 17 of the car. The additional fixing element is a screw configured to be cooperating with the handle and with the part of the car.

The electronic sensing unit 7 includes two distinct sensors and two corresponding fixing mechanisms 21 in FIGS. 1 to 5. In these configurations both sensors are located on the same side than the internal side 15 as described above.

On the further alternative of FIG. 6, the electronic sensing unit 7 includes a further sensor 47 mounted on the external side 23 of the part 17 of the car, the car access assembly 1 including a further fixing element 49 for maintaining the further sensor 47 on the external side 23.

The further sensor 47 is identical to the above described sensor 9, only its location is different. The fact of having a further sensor 47 at another location improves the quality of the acquisition of solicitation of the handle 3.

The further fixing element 49 includes a first part 51 adapted to be received in a further recess of the handle 3 and a second part 53 configured to cooperate with the first part 51.

The first part 51 is a nut and the second part 53 is a screw extending transverse to the reference plane 19. The extension portion 11 and/or bracket 13, the part 17 of the car and the further sensor 47 each presenting a through opening for passage of the screw.

Each strain gauge 25 is linked to a signal transmitting device of the car access assembly (not represented). Each signal transmitting device includes electrical wire(s) or flexible printed circuit board(s) configured to transmit a signal from the sensor 47. The wires can be shielded or not.

The handle 3 is an outside handle of the car for example on the driver side. As used herein, the term “car” is understood to include every kind of vehicle in the automotive industry including bus, truck, personal vehicles etc. The car access assembly includes the car door 5.

The disclosure is not limited to the sole form described above by way of example, it encompasses all the variants.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A car access assembly comprising:
a handle configured to be attached on a car door; and
an electronic sensing unit comprising:
a sensor configured to be attached on at least one of an extension portion of the handle and to a bracket configured to cooperate with the handle, wherein the at least one of the extension portion and the bracket is configured to be installed on or facing an internal side of a part of the car door extending according to a reference plane; and
a fixing mechanism for the sensor, the fixing mechanism being configured to attach together to the part of the car door, the at least one of the extension portion and the bracket, and the sensor so that a constraint applied to the handle is transmitted to the sensor for detection of a command via the at least one of the extension portion and the bracket.

2. The car access assembly according to claim 1, wherein the sensor includes at least one strain gauge, wherein the at least one strain gauge is configured to be deformed when the constraint is applied to the handle.

3. The car access assembly according to claim 1, wherein the at least one of the extension portion of the handle and the bracket extends parallel to the reference plane, wherein the at least one of the extension portion and the bracket is located between the internal side and the sensor transversally to the reference plane.

4. The car access assembly according to claim 3, wherein the at least one of the extension portion and the bracket presents a recess adapted to receive the sensor.

5. The car access assembly according to claim 1, wherein the at least one of the extension portion and the bracket presents a recess adapted to receive the sensor.

6. The car access assembly according to claim 1, wherein the fixing mechanism comprises a main fastener which is configured to extend according to a main direction transversal to the reference plane, the main fastener being configured to cooperate with the sensor, the at least one of the extension portion and the bracket, the part of the car door and the handle.

7. The car access assembly according to claim 6, further comprising a support of the sensor,
wherein the at least one of the extension portion and the bracket, and the part of the car door each presents a corresponding through opening for passage of the main fastener.

8. The car access assembly according to claim 6, wherein the handle comprises a socket adapted to cooperate with the main fastener.

9. The car access assembly according to claim 8 wherein the main fastener is a screw and the socket includes a threaded portion.

10. The car access assembly according to claim 1, wherein the electronic sensing unit comprises two distinct sensors and two corresponding fixing mechanisms.

11. The car access assembly according to claim 1, wherein the electronic sensing unit comprises a further sensor mounted on an external side of the part of the car door, the car access assembly including a further fixing element for maintaining the further sensor on the external side.

12. The car access assembly according to claim 11, wherein, the further fixing element includes a first part adapted to be received in a further recess of the handle and a second part configured to cooperate with the first part.
